(19) United States
(12) Patent Application Publication
(10) Pub. No.: US 2021/0181317 A1
(43) Pub. Date: Jun. 17, 2021

(54) TIME-OF-FLIGHT-BASED DISTANCE MEASUREMENT SYSTEM AND METHOD

(71) Applicant: ORADAR TECHNOLOGY COMPANY LIMITED, Shenzhen (CN)

(72) Inventors: Liang ZHU, SHENZHEN (CN); Ran HE, SHENZHEN (CN); Rui WANG, SHENZHEN (CN); Min YAN, SHENZHEN (CN)

(21) Appl. No.: 17/182,921

(22) Filed: Feb. 23, 2021

Related U.S. Application Data
(63) Continuation of application No. PCT/CN2019/113706, filed on Oct. 28, 2019.

(30) Foreign Application Priority Data
Sep. 19, 2019 (CN) 201910888949.2

(51) Int. Cl. G01S 7/4865; G01S 17/48

(52) U.S. Cl. CPC G01S 7/4866; G01S 7/4863; G01S 17/48

(57) ABSTRACT

This application provides a time of flight (TOF)-based distance measurement system with adjustable histograms, including: an emitter, configured to emit a pulsed beam; a collector, configured to collect a photon in the pulsed beam reflected by an object and form a photonic signal; and a processing circuit, connected to the emitter and the collector, and including a TDC circuit and a histogram circuit. The TDC circuit is configured to receive the photonic signal, calculate a time interval of the photonic signal, and convert the time interval into a time code. The histogram circuit counts photons on a corresponding internal time unit based on the time code, and collects statistics on photon counts in all time units after a plurality of measurements to draw a histogram. An address of the time unit can be dynamically adjusted to dynamically adjust a time resolution and/or a time range width of the histogram.

### CROSS-REFERENCE TO RELATED APPLICATIONS

This application is a continuation application of International Patent Application No. PCT/CN2019/113706, filed on Oct. 28, 2019, which is based on and claims priority to and benefit of Chinese Patent Application No. 201910888949.2, entitled “TIME-OF-FLIGHT-BASED DISTANCE MEASUREMENT SYSTEM AND METHOD WITH ADJUSTABLE HISTOGRAMS,” and filed on Sep. 19, 2019 with the China National Intellectual Property Administration. The content of all of the above-identified applications is incorporated herein by reference in their entirety.

### TECHNICAL FIELD

This application relates to the field of computer technologies, and in particular, to a time of flight (TOF)-based distance measurement system and method with adjustable histograms.

### BACKGROUND

The TOF method calculates a distance to an object by measuring a TOF of a beam in space. Due to advantages such as high precision and large measurement range, the method is widely used in fields such as consumer electronics, autonomous vehicles, and AR/VR.

A distance measurement system based on the TOF principle, such as a TOF depth camera or a lidar, usually includes a light source serving as an emitting end and a receiving end. The light source emits a beam to a target space for illumination, the receiving end receives the beam reflected by a target, and the system calculates a distance to an object by calculating a time required for the beam to be emitted and to be received after being reflected.

At present, lidars based on the TOF method are mainly mechanical and non-mechanical. A lidar of the mechanical type realizes distance measurement of a wide 360-degree field of view by using a rotating base, which has an advantage of large measurement range, but also has problems such as high power consumption and low resolution and frame rate. An area array lidar of the non-mechanical type can resolve the problems of the mechanical lidar to a certain extent, which emits an area beam of a certain field of view into space, and receives the beam through an area array receiver, thereby improving the resolution and the frame rate. In addition, no rotating part is needed, making installation easier. Nevertheless, the area array lidar still faces certain challenges.

A higher resolution of the area array lidar indicates more comprehensive valid information. In addition, dynamic measurement has higher requirements on the frame rate and measurement precision. However, improvement of the resolution, the frame rate, and the precision usually depends on a circuit scale of the receiving end and improvement of a modulation and demodulation method. The circuit scale is increased with higher power consumption, signal-to-noise ratio, and costs. In addition, an amount of on-chip storage is increased, bringing serious challenges to mass production. Moreover, it is difficult for the modulation and demodulation method in existing technologies to meet requirements such as high precision and low power consumption.

### SUMMARY

This application provides a TOF-based distance measurement system and method with adjustable histograms, to resolve at least one of the problems discussed above in BACKGROUND.

The embodiments of this application provide a TOF-based distance measurement system with adjustable histograms, including: an emitter configured to emit a pulsed beam; a collector configured to collect a photon in the pulsed beam reflected by an object to generate a photonic signal; and a processing circuit, connected to the emitter and the collector, and including a TDC circuit and a histogram circuit, wherein the TDC circuit is configured to receive the photonic signal, to calculate a time interval of the photonic signal, and to convert the time interval into a time code; and the histogram circuit counts photons in a corresponding time unit based on the time code, and collects statistics on photon counts in time units after a plurality of measurements to draw a histogram, wherein an address of the time unit is dynamically adjusted to dynamically adjust a time resolution and/or a time range width of the histogram.

In some embodiments, the system further includes: determining a time corresponding to a pulse waveform in the histogram; and determining a TOF of the pulsed beam according to the time corresponding to the pulse waveform.

In some embodiments, the collector includes a single photon avalanche photodiode (SPAD).

In some embodiments, the histogram circuit further includes: an address decoder, configured to receive the time code, and to convert the time code into address information; a storage matrix including a plurality of time units, configured to store a photon count value; and a read/write circuit, configured to perform an operation of adding one to a photon count of the time unit when the address information is consistent with the address of the time unit or is within an address range of the time unit.

In some embodiments, the system is dynamically adjusted to realize two modes: a coarse histogram mode and a fine histogram mode; and a time range width in the coarse histogram mode is greater than a time range width in the fine histogram mode.

The embodiments of this application further provide a TOF-based distance measurement method, including the following steps: emitting a pulsed beam; collecting a photon in the pulsed beam reflected by an object to generate a photonic signal; and receiving the photonic signal, calculating a time interval of the photonic signal, and converting the time interval into a time code; and counting photons in a corresponding time unit based on the time code, and collecting statistics on photon counts in time units after a plurality of measurements to draw a histogram, wherein an address of the time unit is dynamically adjusted to dynamically adjust a time resolution and/or a time range width of the histogram.

In some embodiments, the method further includes: determining a time corresponding to a pulse waveform in the histogram; and determining a TOF of the pulsed beam according to the time corresponding to the pulse waveform.

In some embodiments, the method is dynamically adjusted to realize two modes: a coarse histogram mode and a fine histogram mode; and a time range width in the coarse histogram mode is greater than a time range width in the fine histogram mode.

In some embodiments, a first histogram is drawn in the coarse histogram mode, and a second histogram is drawn in the fine histogram mode based on the first histogram.

In some embodiments, the second histogram is used to determine the TOF of the pulsed beam.

The embodiments of this application provide a TOF-based distance measurement system, including: an emitter configured to emit a pulsed beam; a collector configured to collect a photon in the pulsed beam reflected by an object and generate a photonic signal; and a processing circuit, connected to the emitter and the collector, and including a TDC circuit and a histogram circuit, wherein the TDC circuit is configured to receive the photonic signal, to calculate a time interval of the photonic signal, and to convert the time interval into a time code; and the histogram circuit counts photons in a corresponding internal time unit based on the time code, and collects statistics on photon counts in all time units after a plurality of measurements to draw a histogram, wherein an address of the time unit can be dynamically adjusted to dynamically adjust a time resolution and/or a time range width of the histogram. Dynamic coarse-fine adjustment is performed on histograms in the TOF-based distance measurement system, to realize a large-scale and high-precision TOF measurement, thereby resolving problems of high costs and difficult mass production of the monolithic integration due to a large memory capacity of a histogram circuit in existing technologies.

### BRIEF DESCRIPTION OF THE DRAWINGS

To describe the technical solutions in the embodiments of this application or existing technologies more clearly, the following briefly describes the accompanying drawings required for describing the embodiments or existing technologies. Apparently, the accompanying drawings in the following description show only some embodiments of this application, and a person of ordinary skill in the art may derive other drawings from the accompanying drawings without creative efforts.

FIG. 1 is a schematic diagram of a TOF-based distance measurement system, according to an embodiment of this application.

FIG. 2 is a schematic diagram of a light source, according to an embodiment of this application.

FIG. 3 is a schematic diagram of a pixel unit in a collector, according to an embodiment of this application.

FIG. 4 is a schematic diagram of a read circuit, according to an embodiment of this application.

FIG. 5 is a schematic diagram of a histogram, according to an embodiment of this application.

FIG. 6 shows a TOF measurement method of dynamically drawing histograms, according to an embodiment of this application.

FIG. 7 shows a TOF measurement method, according to an embodiment of this application.

FIG. 8 shows a TOF measurement method based on interpolation, according to an embodiment of this application.

### DETAILED DESCRIPTION

To make the to-be-resolved technical problems—, the technical solutions, and the advantageous effects of the embodiments of this application clearer and more comprehensible, the following further describes this application in detail with reference to the accompanying drawings and embodiments. It should be understood that the specific embodiments described herein are merely used to explain this application but are not intended to limit this application.

It should be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by the terms such as “length,” “width,” “above,” “below,” “front,” “back,” “left,” “right,” “vertical,” “horizontal” “top,” “bottom,” “inside,” and “outside” are based on orientation or position relationships shown in the accompanying drawings, and are used only for ease and brevity of illustration and description of embodiments of this application, rather than indicating or implying that the mentioned apparatus or component needs to have a particular orientation or needs to be constructed and operated in a particular orientation. Therefore, such terms should not be construed as limiting this application.

In addition, terms “first” and “second” are only used for describing the objective and cannot be understood as indicating or implying relative importance or implying a quantity of the indicated technical features. In view of this, a feature defined by “first” or “second” may explicitly or implicitly include one or more features. In the description of the embodiments of this application, unless otherwise specifically limited, “a plurality of” means two or more than two.

In an embodiment of this application, a distance measurement system is provided, which has a stronger resistance to ambient light and has a higher resolution.

FIG. 1 is a schematic diagram of a TOF-based distance measurement system, according to an embodiment of this application. The distance measurement system 10 includes an emitter 11, a collector 12, and a processing circuit 13. The emitter 11 provides an emitted beam 30 to a target space to illuminate an object 20 in the space. At least a portion of the emitted beam 30 is reflected by the object 20 to form a reflected beam 40, and at least a portion of optical signals (photons) of the reflected beam 40 are collected by the collector 12. The processing circuit 13 is connected to the emitter 11 and the collector 12. Trigger signals of the emitter 11 and the collector 12 are synchronized to calculate a time required for the beam to be emitted by the emitter 11 and received by the collector 12, that is, a TOF t between the emitted beam 30 and the reflected beam 40. Further, a distance D to a corresponding point on the object can be calculated by the following formula:

D=c·t/2 (1)

wherein c is a speed of light.

The emitter 11 includes a light source 111 and an optical element 112. The light source 111 may be a light source such as a light emitting diode (LED), an edge emitting laser (EEL), a vertical cavity surface emitting laser (VCSEL), or may be an array light source including a plurality of light sources. In some embodiments, the array light source 111 may be a VCSEL array light source chip formed by forming a plurality of VCSEL light sources on a single semiconductor substrate. A beam emitted by the light source 111 may be visible light, infrared light, ultraviolet light, or the like. The light source 111 emits the beam under the control of the processing circuit 13. For example, in some embodiments, the light source 111 emits a pulsed beam at a certain frequency (pulse period) under the control of the processing circuit 13, which can be used in a direct TOF measurement method with the frequency set according to a to-be-measured distance, for example, set to 1 MHz to 100 MHz. The to-be-measured distance ranges from several meters to several hundred meters. It can be understood that the light source 111 may be controlled to emit related beams by a portion of the processing circuit 13 or a sub-circuit independent of the processing circuit 13, such as a pulse signal generator.

The optical element 112 receives the pulsed beam from the light source 111, performs optical modulation such as diffraction, refraction, or reflection on the pulsed beam, and emits a modulated beam such as a focused beam, a flood beam, or a structured light beam into the space. The optical element 112 may be one or a combination of a lens, a diffractive optical element, a mask, a mirror, a MEMS galvanometer, and the like.

The processing circuit 13 may be an independent dedicated circuit, such as a dedicated SOC chip, FPGA chip, or ASIC chip, or may include a general-purpose processor. For example, when a depth camera is integrated into a smart terminal such as a mobile phone, a television, or a computer, a processor in the terminal may be used as at least a portion of the processing circuit 13.

The collector 12 includes a pixel unit 121 and an imaging lens unit 122. The imaging lens unit 122 receives at least a portion of the modulated beam reflected by the object and guides the portion to the pixel unit 121. In some embodiments, the pixel unit 121 includes a SPAD, or may be an array pixel unit including a plurality of SPAD pixels. An array size of the array pixel unit represents a resolution of the depth camera, such as 320×240. The SPAD can respond to a single input photon to detect the single photon, which can achieve long-distance and high-precision measurement due to high sensitivity and fast response speed. Compared with an image sensor including a CCD/CMOS and based on the principle of light integration, the SPAD can collect a weak light signal and calculate a TOF by counting single photons, for example, using a time-correlated single-photon counting (TCSPC) method. Generally, a read circuit (not shown in the figure) is further connected to the pixel unit 121, and includes one or more of devices such as a signal amplifier, a time-to-digital converter (TDC), and an analog-to-digital converter (ADC). The circuit may be integrated with the pixel unit, or may be a portion of the processing circuit 13. For ease of description, the circuit is considered as a portion of the processing circuit 13 in the embodiments of this application.

In some embodiments, the distance measurement system 10 may further include devices such as a color camera, an infrared camera, and an IMU. Combination with such devices can achieve more functions, such as 3D texture modeling, infrared face recognition, and Simultaneous Localization And Mapping (SLAM).

In some embodiments, the emitter 11 and the collector 12 may be disposed in a coaxial form, that is, the two are implemented by an optical device with reflection and transmission functions, such as a half mirror.

In the direct-TOF-based distance measurement system using a SPAD, a single photon input to the SPAD pixel may cause an avalanche. The SPAD outputs an avalanche signal to a TDC circuit, and the TDC circuit detects a time interval from when the photon is emitted from the emitter 11 to when the avalanche is caused. After a plurality of measurements, a histogram statistics collection is performed on time intervals by using a TCSPC circuit to restore a waveform of an entire pulse signal, and a time corresponding to the waveform can be further determined. A TOF can be determined according to the time, thereby realizing a precise TOF detection. Finally, distance information of the object is calculated according to the TOF. Assuming that a pulse period of emitting the pulsed beam is At and a maximum measurement range of the distance measurement system is Dmax, a corresponding maximum TOF is t1=2Dmax/c. Generally, Δt≥t₁ is required to avoid signal confusion, wherein c is a speed of light. If the number of the plurality of measurements required by TCSPC is n, a time (frame period) for a single frame of measurement is not less than n*t1, that is, a period of each frame of measurement includes n photon count measurements. For example, the maximum measurement range is 150 m, and a corresponding pulse period Δt=1 us, and n=100000. Then, the frame period is not less than 100 ms, and a frame rate is less than 10 fps. As such, the maximum measurement range in the TCSPC method may limit the pulse period, and affect the frame rate of distance measurement.

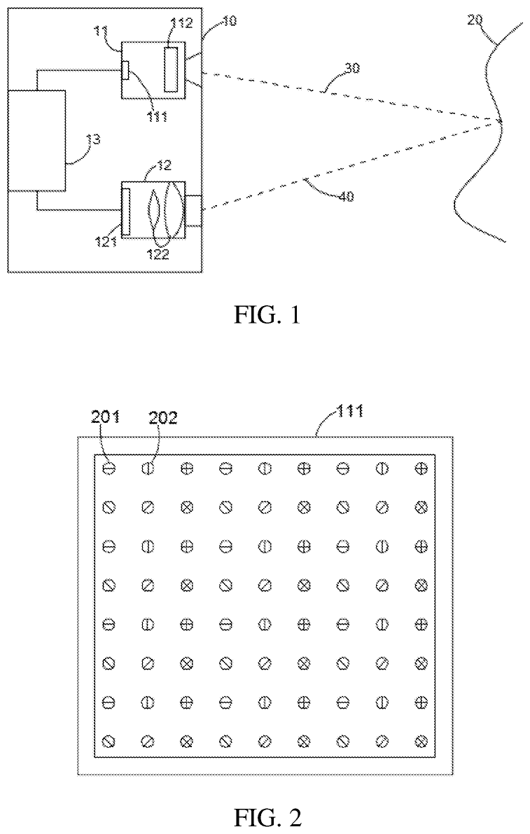

FIG. 2 is a schematic diagram of a light source, according to an embodiment of this application. The light source 111 includes a plurality of sub-light sources disposed on a single substrate (or a plurality of substrates). The sub-light sources are arranged on the substrate in a certain pattern. The substrate may be a semiconductor substrate, a metal substrate, or the like. The sub-light source may be an LED, an EEL, a VCSEL, or the like. In some embodiments, the light source 111 is an array VCSEL chip including a plurality of VCSEL sub-light sources disposed on the semiconductor substrate. The sub-light source is configured to emit a beam of any desired wavelength, such as visible light, infrared light, or ultraviolet light. The light source 111 emits light under modulation such as continuous wave modulation or pulse modulation driven by a driving circuit (which may be a portion of the processing circuit 13). The light source 111 may emit light in groups or as a whole under the control of the driving circuit. For example, the light source 111 includes a first sub-light source array 201, and a second sub-light source array 202. The first sub-light source array 201 emits light under the control of a first driving circuit, and the second sub-light source array 202 emits light under the control of a second driving circuit. The sub-light sources may be arranged in a one-dimensional or two-dimensional mode, or may be arranged regularly or irregularly. To facilitate analysis, only one example is schematically shown in FIG. 2. In the example, the light source 111 is a regular array of 8×9 sub-light sources, and the sub-light sources are divided into 4×3=12 groups. The light sources are distinguished using different symbols in the figure, that is, the light source 111 includes 12 arrays of regularly arranged 3×2 sub-light sources.

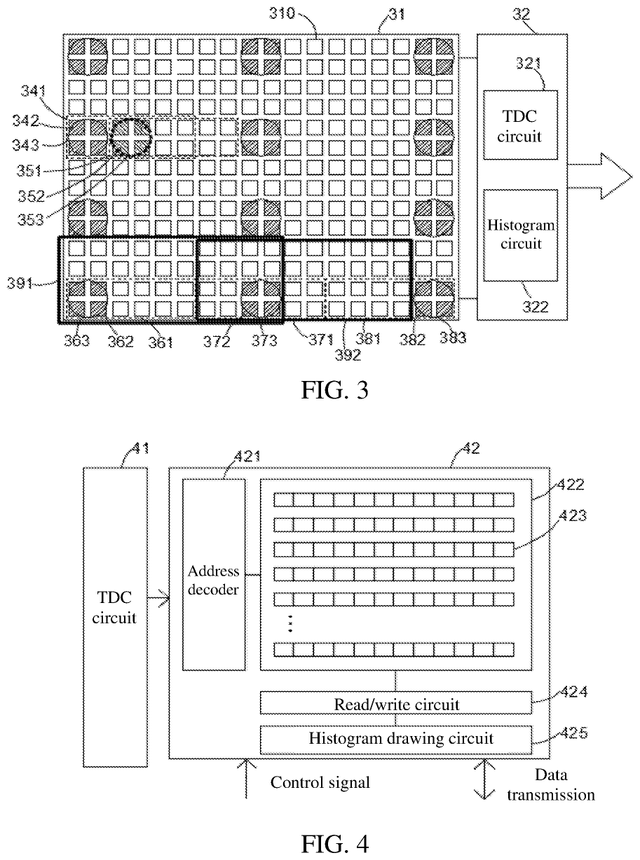

FIG. 3 is a schematic diagram of a pixel unit in a collector, according to an embodiment of this application. The pixel unit includes a pixel array 31 and a read circuit 32. The pixel array 31 includes a two-dimensional array including a plurality of pixels 310, and the read circuit 32 includes a TDC circuit 321, a histogram circuit 322, and the like. The pixel array is configured to collect at least a portion of the beam reflected by the object and generate a corresponding photonic signal. The read circuit 32 is configured to process the photonic signal to draw a histogram reflecting the pulse waveform emitted by the light source in the emitter. Further, a TOF may be calculated according to the histogram, and finally a result is output. The read circuit 32 may include a single TDC circuit and histogram circuit, or may be an array of a plurality of TDC circuit units and histogram circuit units.

In some embodiments, when the emitter 11 emits a spot beam to a to-be-measured object, the optical element 112 in the collector 12 guides the spot beam to a corresponding pixel. Generally, in order to receive optical signals of a reflected beam as many as possible, a size of a single spot is set to correspond to a plurality of pixels (the correspondence here can be understood as imaging, and the optical element 112 generally includes an imaging lens). For example, a single spot in FIG. 3 corresponds to 2×2=4 pixels, that is, a photon of the reflected spot beam is received by 4 corresponding pixels with a certain probability. For ease of description, in this application, a pixel area including a plurality of corresponding pixels is referred to as a “combined pixel.” A size of the combined pixel may be set according to actual requirements, including at least one pixel, for example, the size may be 3×3 or 4×4. Generally, a light spot is round, elliptical, or the like. The size of the combined pixel needs to be set to be equivalent to or slightly smaller than a size of the light spot. However, considering different magnifications caused by different distances to the measured object, the size of the combined pixel needs to be considered comprehensively during setting.

In the embodiment shown in FIG. 3, an example that the pixel unit 31 includes an array including 14×18 pixels is used for description. Generally, the measurement system 10 may be coaxial or non-coaxial according to different setting modes between the emitter 11 and the collector 12. For the coaxial case, the beam emitted by the emitter 11 is collected by a corresponding combined pixel in the collector 12 after being reflected by the measured object, and a position of the combined pixel is not affected by a distance of the measured object. However, for the non-coaxial case, due to parallax, a position of a light spot falling on the pixel unit varies with different distances to the measured object, and usually shifts along a baseline (a line between the emitter 11 and the collector 12, wherein a horizontal direction is used to represent a baseline direction in this application) direction. Therefore, when the distance to the measured object is unknown, the position of the combined pixel is uncertain. To resolve this problem, this application sets a pixel area (herein referred to as a “super pixel”) including a plurality of pixels exceeding a quantity of pixels in the combined pixel, to receive a reflected spot beam. During setting of the size of the super pixel, both a measurement range of the system 10 and a length of the baseline need to be considered, so that combined pixels corresponding to spots reflected by objects at different distances within the measurement range all fall into the super pixel area, that is, the size of the super pixel needs to exceed that of at least one combined pixel. Generally, the size of the super pixel is the same as that of the combined pixel along a vertical direction of the baseline, and is larger than that of the combined pixel along the baseline direction. A quantity of super pixels is generally the same as a quantity of spot beams collected by the collector 12 in a single measurement, such as 4×3 in FIG. 3.

In some embodiments, the super pixel is set to as follows. When at a lower limit of the measurement range, that is, at a short distance, the spot falls on one side of the super pixel (a left or right side, depending on a relative position between the emitter 11 and the collector 12), and when at an upper limit of the measurement range, that is, at a long distance, the spot falls on the other side of the super pixel. In the embodiment shown in FIG. 3, the super pixel is set to a size of 2×6. For example, for spots 363, 373, and 383, corresponding super pixels are 361, 371, and 381 respectively. The spots 363, 373, and 383 are spot beams respectively reflected by objects from long, medium, and short distances. Corresponding combined pixels fall on the left side, middle, and the right side of the super pixels.

In some embodiments, the combined pixel shares one TDC circuit unit, that is, one TDC circuit unit is connected to each pixel in the combined pixel. When any one of the pixels in the combined pixel receives a photon and generates a photonic signal, the TDC circuit unit can calculate a TOF corresponding to the photonic signal. Such a case is more suitable for the coaxial case, but not for the non-coaxial case since the position of the combined pixel varies with the distance to the measured object in the non-coaxial case. In the embodiment shown in FIG. 3, the TDC circuit 321 may include a TDC circuit array including 4×3 TDC circuit units.

In some embodiments, pixels in one super pixel share one TDC circuit unit, that is, one TDC circuit unit is connected to each pixel in the super pixel. When any one of the pixels in the super pixel receives a photon and generates a photonic signal, the TDC circuit unit can calculate a TOF corresponding to the photonic signal. Because the super pixel may include a combined pixel shift caused by the parallax in the non-coaxial case, the super pixel sharing the TDC is applicable to the non-coaxial case. In the embodiment shown in FIG. 3, the TDC circuit 321 may comprise a TDC circuit array including 4×3 TDC circuit units. The TDC circuit can be shared to effectively reduce a quantity of the TDC circuits, thereby reducing a size and power consumption of the read circuit.

For the non-coaxial case, more pixels need to be set to form the super pixel. In a time of a single measurement (or single exposure), a quantity of spots that can be collected is much less than a quantity of pixels. In other words, a resolution of collected valid depth data (a TOF value) is much less than a resolution of the pixels. For example, a resolution of the pixels in FIG. 3 is 14×18, while a distribution of the spots is 4×3, that is, a resolution of valid depth data of a single frame of measurement is 4×3.

To improve the resolution of the measured depth data, a multi-frame measurement method can be used. Spots emitted by the emitter 11 during multi-frame measurement “deviate,” resulting in a scanning effect. Spots received by the collector 12 also deviate in the multi-frame measurement. For example, spots corresponding to two adjacent frames of measurement in FIG. 3 are 343 and 353 respectively. In this way, the resolution can be improved. In some embodiments, “deviation” of the spots may be realized through group control of the sub-light sources on the light source 111, that is, in two or more adjacent frames of measurement, adjacent sub-light sources are sequentially turned on. For example, in the first frame of measurement, the first sub-light source array 201 is turned on, in the second frame of measurement, the second sub-light source array 202 is turned on, and so on. In addition to a horizontal group control, a vertical group control may be performed to improve the resolution of the valid depth data in a two-dimensional direction.

For the “deviation” of the spots in the multi-frame measurement, super pixels corresponding to spots at different positions also need to be deviated during setting. As shown in FIG. 3, a super pixel 341 corresponds to the spot 343, and a super pixel 351 corresponds to the spot 353. The super pixel 351 is horizontally shifted relative to the super pixel 341, and there is an overlap of pixels between the super pixel 341 and the super pixel 351. For the occasions of overlapping among super pixels in the multi-frame measurement, to ensure that the TDC circuit can accurately perform photon counting and TOF measurement on a corresponding super pixel in each frame, this application provides a dual TDC circuit sharing solution.

In some embodiments, a pixel area connected to a single TDC circuit unit includes an area including all super pixels that deviate in the multi-frame measurement, and pixel areas corresponding to two adjacent TDC circuit units overlap. In the embodiment shown in FIG. 3, a pixel area 391 shares a TDC circuit unit, and the pixel area 391 includes 6 super pixels corresponding to 6 frames of measurement when 6 groups of sub-light sources are turned on sequentially. Similarly, an adjacent pixel area 392 shares a TDC circuit unit. The two pixel areas 391 and 392 overlap, resulting in that a portion of pixels are connected to the two TDC circuit units. In a single frame of measurement, according to the projected spots, the processing circuit 13 gates a corresponding pixel so that an obtained photonic signal can be measured by a single TDC circuit unit, so as to avoid crosstalk and errors. In some embodiments, a quantity of TDC circuits is the same as a quantity of spots collected by the collector 12 during a single frame of measurement, and the quantity is 4×3 in FIG. 3. Each shared TDC circuit is connected to 4×10 pixels. There is an overlap of 4×4 pixels between a pixel area connected to adjacent TDC circuit units.

The following describes a solution of an adjustable histogram circuit. In a single frame measurement period, the TDC circuit receives a photonic signal from a pixel in the super pixel area connected thereto, and calculates a time interval (that is, a TOF) between the signal and a start clock signal, and converts the time interval into a temperature code or a binary code for storage in the histogram circuit. After a plurality of measurements, the histogram circuit can draw a histogram reflecting a pulse waveform. Based on the histogram, a TOF of the pulse can be accurately obtained. Generally, a larger measurement range requires a wider measurable time range of the TDC circuit. A higher precision requirement requires a higher time resolution of the TDC circuit. Both a wider time range and a higher time resolution requires the TDC circuit to have a larger scale to output a binary code with a larger quantity of bits. Due to an increase of the quantity of bits of the binary code, a memory of the histogram circuit is required to have a higher storage capacity. A larger memory capacity indicates higher costs and more difficult mass production of monolithic integration. Therefore, this application provides a read circuit solution with adjustable histogram circuit.

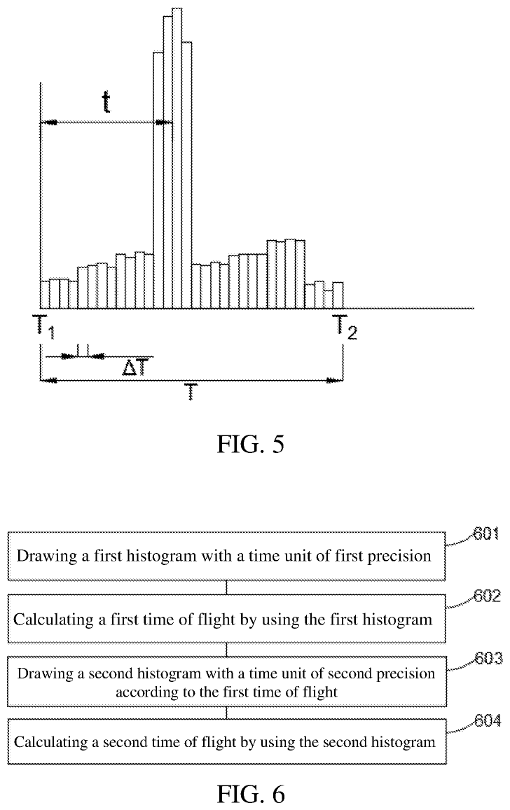

FIG. 4 is a schematic diagram of a read circuit, according to an embodiment of this application. The read circuit includes a TDC circuit 41 and a histogram circuit 42. The TDC circuit 41 collects a time interval of a photonic signal and converts the time interval into a time code (a binary code, a temperature code, or the like). Then the histogram circuit 42 counts, for example, performs an operation of adding one (i.e., adds one to the photon count of the time unit) to a corresponding internal time unit (that is, a storage unit configured to store time information) based on the time code. After a plurality of measurements, statistics on photon counts in all time units may be collected and a time histogram may be drawn. The histogram drawn is shown in FIG. 5. ΔT refers to a width of the time unit, T1 and T2 respectively refer to start and end times of the histogram, [T1, T2] is a time range of the histogram, and T=T2−T1 refers to a total time width. A vertical ordinate of the time unit ΔT is a photon count value stored in a corresponding storage unit. Based on the histogram, a method such as a maximum peak method may be used to determine a position of a pulse waveform, and obtain a corresponding TOF t.

In some embodiments, the histogram circuit 42 includes an address decoder 421, a storage matrix 422, a read/write circuit 424, and a histogram drawing circuit 425. The TDC circuit inputs the obtained time code (binary code, temperature code, or the like) reflecting the time interval to the address decoder 421. The address decoder 421 converts the time code into address information. The address information is stored in the storage matrix 422. The storage matrix 422 includes a plurality of storage units 423, that is, time units. Each storage unit 423 is pre-configured with a certain address (or an address range). When the address of the time code received by the address decoder 421 is consistent with an address of a storage unit or within an address range of the storage unit, the read/write circuit 424 performs perform an operation of adding one to the corresponding storage unit, that is, completes one photon count. After a plurality of measurements, data of each storage unit reflects a quantity of photons received during the time interval. After a plurality of single frames of measurement, data of all the storage units in the storage matrix 422 is read and sent to the histogram drawing circuit 425 for histogram drawing.

To reduce a required storage capacity of the storage matrix as much as possible, in practice, a quantity of the storage units 423 needs to be reduced. Therefore, in this application, a control signal is applied to the histogram circuit 42 through the processing circuit to dynamically set the addresses (or the address range) of each storage unit 423, so as to dynamically control the time resolution ΔT and/or the time range width T of the histogram. For example, under the premise that the quantity of storage units 423 remains unchanged, if the address range corresponding to the storage unit 423 is set to a larger time interval, that is, increasing the width of the time unit ΔT, an overall time range that the storage matrix can store is larger, and an overall time range of the histogram is larger. For ease of description, a histogram with a larger time range is referred to as a coarse histogram. In another example, the address range corresponding to the storage unit 423 may be set to a smaller time interval. An overall time range that the storage matrix can store is reduced, but the time resolution of storage increases, and the time resolution of the histogram increases. Compared with the coarse histogram, a histogram with a smaller time range is referred to as a fine histogram.

In this application, large-scale and high-precision TOF measurement is realized by performing a dynamic coarse-fine adjustment on the histogram during the TOF measurement process.

FIG. 6 is a schematic diagram of a TOF measurement method based on dynamic histogram drawing, according to an embodiment of this application. The method includes the following steps.

Step 601: Drawing a first (or coarse) histogram with a time unit of first (or coarse) precision. An address or an address range corresponding to each time unit in the storage matrix 422 is configured by applying a control signal. In other words, T and ΔT are set. ΔT is configured to a larger time interval in this step. Generally, the time range T of the histogram needs to be set in consideration of the measurement range. The time interval needs to be set in consideration of the measurement range and a quantity of histogram storage units, that is, the TOF corresponding to the measurement range is allocated, for example, equally or unequally, to all the histogram storage units, so that all the storage units can cover the measurement range. After a plurality of measurements, a TOF value obtained from each measurement is matched to perform an operation of adding one to a corresponding time unit. Finally, the coarse histogram is drawn.

Step 602: Calculating a first (rough) TOF value t1 by using the first (coarse) histogram. Based on the coarse histogram, a method such as a maximum peak value method may be used to find a position of a pulse waveform, and a corresponding TOF may be read as the rough TOF value t1. Precision or a minimum resolution of the TOF value is the time interval ΔT1 of the time unit.

When a measurement range is relatively large and a quantity of storage units is limited, ΔT1 is relatively large. When a quantity of photons is large, a pulsed photon is submerged in background light, making it impossible to detect the pulse waveform. Therefore, in some embodiments, the measurement range may be divided into several sections. Each section corresponds to a respective TOF range, and time intervals ΔT of all time ranges T may be the same or different. The coarse histogram may be drawn based on the time ranges one by one. Because a distance to a measured object is unknown, a time range within which a TOF corresponding to the object falls is also unknown. Therefore, when the coarse histogram is drawn within a time range, a pulse waveform may not be detected, that is, a rough TOF value cannot be calculated. In this case, for example, when the position of the waveform cannot be found based on the coarse histogram in step 602, step 601 is performed again to draw a next coarse histogram, until the pulse waveform is found in the coarse histogram. Certainly, it is possible that the pulse waveform cannot be found all the time due to errors or an excessively long distance to the object. To avoid a problem of continuous cyclical detection, a quantity of cycles may be set. For example, when a quantity of drawn coarse histograms exceeds a certain threshold (such as 3), it is considered that no target is detected this time, or a target is located at infinity this time. Therefore, the measurement is ended.

Step 603: Drawing a second (or fine) histogram with a time unit of second precision (e.g., a fine time unit) according to the first TOF (e.g., the obtained rough TOF value). In this case, because the rough TOF value is known, one more round of a plurality of measurements may be performed and a corresponding histogram may be drawn. The address or the address range corresponding to each time unit in the storage matrix 422 is configured to a smaller time interval ΔT2 by the histogram circuit under the control of a control signal. Generally, the time interval ΔT2 only needs to be set to correspond to a smaller measurement range that can include a true TOF value and a quantity of histogram storage units. The measurement range may be set to a range with the rough TOF value as a middle value plus and minus a variable, for example, set to [t1−T′, t1−T′]. T′ being set smaller indicates a smaller time interval ΔT2 and a higher resolution. For example, in some embodiments, T′=5% T, so that a sum of time intervals of all time units is only 10% of the time range corresponding to the coarse histogram. In other embodiments, a ratio of the variable to the time range of the coarse histogram may be set within a range of 1% to 25%. Then a new round of a plurality of measurements is performed. A TOF value obtained each time is matched to perform a plus 1 operation on a corresponding time unit, to draw the fine histogram.

Step 604: Calculating a second (fine) TOF value t2 by using the second (fine) histogram. Based on the fine histogram, a method such as the maximum peak value method may be used to find a position of a pulse waveform, and a corresponding TOF may be read as the fine TOF value t2. Precision or a minimum resolution of the TOF value is the time interval ΔT2 of the time unit. If the setting of T′=5% T in step 603 is used for description, the precision of the fine TOF is improved by 10 times (the minimum resolution is improved by 10 times) compared with the rough TOF.

The measurement method based on the dynamic coarse-fine histogram adjustment is essentially a process of performing rough positioning within a larger measurement range, and then performing the fine measurement based on a positioning result. It can be understood that the above coarse-fine adjustment method may alternatively be extended to three or more steps of measurement. For example, in some embodiments, a first time resolution is used for measurement to obtain a first TOF, then a second time resolution is used for measurement to obtain a second TOF based on the first TOF, and a third time resolution is finally used for measurement to obtain a third TOF based on the second TOF. The precision of the three measurements is gradually improved, and finally measurement with higher precision can be realized.

In some embodiments, because only TOF values within the time range T are counted when the histogram is drawn, each pixel in the collector 12 of the measurement system may be activated (enabled) within a specified time range, thereby reducing power consumption. The specified time range generally includes the time range T of the drawn histogram. For example, when the time range of the histogram is [3 ns, 10 ns], the time range within which the pixel is activated may be set to [2.5 ns, 10.5 ns].

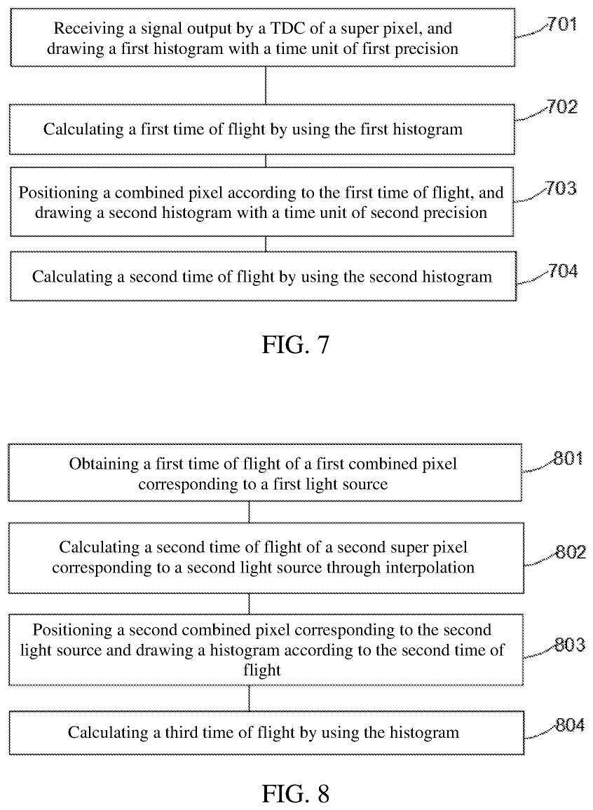

It can be understood that the above measurement method is not only applicable to a coaxial distance measurement system, but also applicable to a non-coaxial measurement system. In particular, it should be noted that in a non-coaxial measurement system including the collector shown in FIG. 3, the dynamic histogram adjustment solution can be further used for super pixel positioning, to improve precision and reduce power consumption. FIG. 7 is a schematic diagram of a TOF measurement method, according to another embodiment of this application. The following provides a description with reference to FIG. 3. The TOF measurement method includes the following steps.

Step 701: Receiving a signal output by a TDC of a super pixel, and drawing a first (coarse) histogram with a time unit of first (coarse) precision. Because a distance to an object is not clear before the measurement, a position of a spot cannot be determined, that is, a position of a combined pixel cannot be determined. The combined pixel may fall at different positions of the super pixel according to the distance to the object. Therefore, in this step, each pixel in the super pixel is first enabled in an active state to receive a photon, and receive a photonic signal output by the TDC shared by the super pixel. Then the histogram is drawn. The histogram uses the dynamic histogram adjustment solution shown in FIG. 6. In this step, the coarse histogram is drawn with a time unit of coarse precision.

Step 702: Calculating a first (rough) TOF value t1 by using the first (coarse) histogram. Based on the coarse histogram, a method such as a maximum peak value method may be used to find a position of a waveform, and a corresponding TOF may be read as the rough TOF value t1. Precision or a minimum resolution of the TOF value is the time interval ΔT1 of the time unit.

When a measurement range is relatively large and a quantity of storage units is limited, ΔT1 is relatively large. When a quantity of photons is large, a pulsed photon is submerged in background light, making it impossible to detect the pulse waveform. Therefore, in some embodiments, the measurement range may be divided into several sections. Each section corresponds to a respective TOF range, and time intervals ΔT of all time ranges T may be the same or different. The coarse histogram may be drawn based on the time ranges one by one. Because the distance to the measured object is unknown, a time range within which a TOF corresponding to the object falls is also unknown. Therefore, when the coarse histogram is drawn within a time range, a pulse waveform may not be detected. In this case, for example, when the position of the waveform cannot be found based on the coarse histogram in step 702, step 701 is performed again to draw a next coarse histogram, until the pulse waveform is found in the coarse histogram. Certainly, it is possible that the pulse waveform cannot be found all the time due to errors or an excessively long distance to the object. To avoid a problem of continuous cyclical detection, a quantity of cycles may be set. For example, when a quantity of drawn coarse histograms exceeds a certain threshold (such as 3), it is considered that no target is detected this time, or a target is located at infinity this time. Therefore, the measurement is ended.

Step 703: Positioning a combined pixel and drawing a second (fine) histogram with a time unit of second precision (a fine time unit) according to the first TOF (the obtained rough TOF value). Because the rough TOF value is determined, a position of the combined pixel may be determined based on the rough TOF value and a parallax. Generally, a relationship between the position of the combined pixel and the rough TOF value needs to be stored in the system in advance, to determine the position of the combined pixel directly according to the relationship after obtaining the rough TOF value. Then, only the combined pixel is activated based on the position of the combined pixel, and a fine histogram is drawn with a fine time unit. Because the rough TOF value is known, one more round of a plurality of measurements may be performed and a corresponding histogram may be drawn. In this case, the address or the address range corresponding to each time unit in the storage matrix 422 is configured to a smaller time interval ΔT2 by the histogram circuit under the control of a control signal. Generally, the time interval ΔT2 only needs to be set to correspond to a smaller measurement range that can include a true TOF value and a quantity of histogram storage units. The measurement range may be set to a range with the rough TOF value as a middle value plus and minus a variable, for example, set to [t1−T′, t1−T′]. T′ being set smaller indicates a smaller time interval ΔT2 and a higher resolution. For example, in some embodiments, T′=5% T, so that a sum of time intervals of all time units is only 10% of the time range corresponding to the coarse histogram. In other embodiments, a ratio of the variable to the time range of the coarse histogram may be set within a range of 1% to 25%. Then a new round of a plurality of measurements is performed. A TOF value obtained each time is matched to perform a plus 1 operation on a corresponding time unit, to draw the fine histogram.

Step 704: Calculating a second (fine) TOF value t2 by using the second (fine) histogram. Based on the fine histogram, a method such as the maximum peak value method may be used to find a position of a pulse waveform, and a corresponding TOF may be read as the fine TOF value t2. Precision or a minimum resolution of the TOF value is the time interval ΔT2 of the time unit. If the setting of T′=5% T in step 703 is used for description, the precision of the fine TOF is improved by 10 times (the minimum resolution is improved by 10 times) compared with the rough TOF.

The measurement method based on dynamic coarse-fine histogram adjustment is essentially a process of performing rough positioning within a larger measurement range, and then performing fine measurement based on a positioning result. It can be understood that the above coarse-fine adjustment method may alternatively be extended to three or more steps of measurement. For example, in some embodiments, a first time resolution is used for measurement to obtain a first TOF, then a second time resolution is used for measurement to obtain a second TOF based on the first TOF, and a third time resolution is finally used for measurement to obtain a third TOF based on the second TOF. The precision of the three measurements is gradually improved, and finally measurement with higher precision can be realized.

In some embodiments, because only TOF values within the time range T are counted when the histogram is drawn, each pixel in the collector 12 of the measurement system may be activated (enabled) within a specified time range, thereby reducing power consumption. The specified time range generally includes the time range T of the drawn histogram. For example, when the time range of the histogram is [3 ns, 10 ns], the time range within which the pixel is activated may be set to [2.5 ns, 10.5 ns].

The following describes a TOF measurement method based on interpolation. The embodiments in FIG. 2 and FIG. 3 introduce examples of improving a resolution through multi-frame measurement. It can be understood that when multi-frame measurement is performed, depth data of each frame may use the dynamic histogram adjustment solution shown in FIG. 6 or FIG. 7. For example, when the first sub-light source array 201 is turned on, dynamic coarse and fine histograms are drawn to obtain a first frame of depth image, when the second sub-light source array 202 is turned on, dynamic coarse and fine histograms are drawn to obtain a second frame of depth image, and the first and second frames of depth images are fused to obtain a depth image with a higher resolution. In some embodiments, more than 3 frames of depth images may alternatively be collected and fused into a depth image with a higher resolution.

However, if dynamic coarse-fine adjustment needs to be performed on each frame of depth image during collection, a collection time of each high-resolution fused depth image is relatively long, and an overall frame rate is low. To improve the frame rate as much as possible, this application provides a TOF measurement method based on interpolation, as shown in FIG. 8. The method includes the following steps.

Step 801: Obtaining a first TOF of a first combined pixel corresponding to a first light source. In this step, the first light source in the emitter 11 is turned on to emit a spot beam corresponding to the first light source. The spot beam falls on the combined pixel on the pixel unit 31 in the collector 12. A spot represented by a solid-line circle of 4×3 in FIG. 3 is used as an example. The processing circuit may further obtain the first TOF of the combined pixel. For example, the dynamic coarse-fine adjustment solution in the embodiment shown in FIG. 6 or FIG. 7 or any other solution may be used to obtain a fine TOF (the first TOF) of the combined pixel.

Step 802: Calculating a second TOF of a second super pixel corresponding to a second light source through interpolation. When the second light source is turned on, a spot beam adjacent to the spot beam corresponding to the first light source is emitted, and the spot beam also falls on a combined pixel of the collector 12. For ease of illustration, only a spot 353 is drawn in FIG. 3 by a dotted-line circle. The spot 353 and the spot 343 are spatially separated because the positions of the first light source and the second light source are separated, and therefore respective corresponding pixels are also separated. Generally, when space points are relatively close, a distance between the two points is not excessively long. Therefore, in some embodiments, the TOF value corresponding to the combined pixel corresponding to the spot 343 obtained in step 801 may be used as the second TOF value (a rough TOF) of the super pixel 351 corresponding to the spot 353, and a fine TOF is calculated later. In some embodiments, the second TOF value of the super pixel of the spot 353 may be estimated by using combined pixels corresponding to a plurality of first light sources around the spot 353, for example, using TOF values of the left and right combined pixels for interpolation. The interpolation may be one-dimensional interpolation or two-dimensional interpolation. The interpolation method may be at least one of interpolation methods such as linear interpolation, spline interpolation, and polynomial interpolation.

Step 803: Positioning a second combined pixel corresponding to the second light source and drawing a histogram according to the second TOF. After the second TOF is obtained through interpolation, the position of the spot in the super pixel, that is, the position of the combined pixel, may be determined based on the TOF and a parallax. Then based on the position of the combined pixel, only the combined pixel is activated, and the histogram is drawn with a fine time unit.

Step 804: Calculating a third TOF by using the histogram. Based on the histogram, a method such as a maximum peak value method may be used to find a position of a pulse waveform, and a corresponding TOF may be read as the third (fine) TOF value t2. Precision or a minimum resolution of the TOF value is the time interval ΔT2 of the time unit.

Compared with the method described in FIG. 6 or FIG. 7, the TOF measurement method in the above steps uses the coarse-fine histogram drawing method for TOF calculation of only a few spots. At least TOF measurement of 2 frames are needed to obtain a TOF value with a high precision. TOFs of most spots may be calculated through interpolation using a known TOF value of a spot as a rough TOF value of a coarse histogram. Based on the rough TOF value, only a single fine histogram needs to be drawn, thereby greatly improving the efficiency. For example, if the light sources are divided into 6 groups, only the first group of light sources requires coarse and fine measurements when turned on, and the other 5 groups require only a single fine measurement for TOF measurement after being turned on.

In some embodiments, a surface of the measured object often has jumps, that is, a distance difference is large. In this case, it is difficult to obtain an accurate TOF value through interpolation since a fine measurement performed based on a result of the interpolation is prone to errors. Therefore, a judgment may be made before the interpolation in step 802. For example, when a difference between TOF values of combined pixels corresponding to a plurality of spots (such as the left and right spots) involved in interpolation is greater than a threshold, it indicates that there is a jump in a surface depth value of the object between the two spots. Spots between the two spots still use the measurement solution of coarse-fine histogram drawing. Only when the difference is less than the threshold, calculation is performed through interpolation.

In some embodiments, the first TOF of the first combined pixel may alternatively be a rough TOF, that is, only a single coarse histogram needs to be drawn to calculate the first TOF of the first combined pixel. Then, interpolation is performed based on the rough TOF obtained by using the drawn coarse histogram.

It can be understood that when the distance measurement system of this application is embedded in a device or hardware, a corresponding structure or component may be changed to adapt to requirements with the essence still using the distance measurement system of this application. Therefore, it still falls within the protection scope of this application. The foregoing contents are merely detailed descriptions of this application in conjunction with specific/exemplary embodiments, and this application is not limited to these descriptions. A person of ordinary skill in the art, to which this application belong, may make various replacements or variations on the described implementations without departing from the principle of this application, and the replacements or variations also fall within the protection scope of this application.

In the descriptions of this specification, descriptions using reference terms “an embodiment,” “some embodiments,” “an exemplary embodiment,” “an example,” “a specific example,” or “some examples” mean that specific characteristics, structures, materials, or features described with reference to the embodiment or example are included in at least one embodiment or example of this application. In this specification, schematic descriptions of the foregoing terms are not necessarily directed at the same embodiment or example. In addition, the described specific features, structures, materials, or features can be combined in a proper manner in any one or more embodiments or examples.

In addition, without contradiction with each other, a person skilled in the art may combine different embodiments or examples and features of the different embodiments or examples described in this specification. Although the embodiments of this application and advantages thereof have been described in detail, it should be understood that various changes, substitutions, and alterations can be made herein without departing from the scope defined by the appended claims. In addition, the scope of this application is not limited to the specific embodiments of the processes, machines, manufacturing, material composition, means, methods, and steps described in the specification. A person of ordinary skill in the art can easily understand and use the above disclosures, processes, machines, manufacturing, material composition, means, methods, and steps that currently exist or will be developed later and that perform substantially the same functions as the corresponding embodiments described herein or obtain substantially the same results as the embodiments described herein. Therefore, the appended claims intend to include such processes, machines, manufacturing, material compositions, means, methods, or steps within the scope thereof.

What is claimed is:

1. A time of flight (TOF)-based distance measurement system, comprising:
an emitter, configured to emit a pulsed beam;
a collector configured to collect a photon in the pulsed beam reflected by an object to generate a photonic signal; and
a processing circuit, connected to the emitter and the collector, and comprising a time-to-digital converter (TDC) circuit and a histogram circuit, wherein the TDC circuit is configured to receive the photonic signal, to calculate a time interval of the photonic signal and to convert the time interval into a time code, and the histogram circuit counts photons in a corresponding time unit based on the time code and collects statistics on photon counts in time units after a plurality of measurements to draw a histogram, wherein
an address of the time unit is dynamically adjusted to dynamically adjust a time resolution and/or a time range width of the histogram.

2. The TOF-based distance measurement system according to claim 1, further comprising:
determining a time corresponding to a pulse waveform in the histogram; and
determining a TOF of the pulsed beam according to the time corresponding to the pulse waveform.

3. The TOF-based distance measurement system according to claim 1, wherein the collector comprises a single photon avalanche photodiode.

4. The TOF-based distance measurement system according to claim 1, wherein the histogram circuit further comprises:
an address decoder configured to receive the time code, and to convert the time code into address information;
a storage matrix comprising a plurality of time units configured to store a photon count value; and
a read/write circuit configured to perform an operation of adding one to a photon count of the time unit when the address information is consistent with the address of the time unit or is within an address range of the time unit.

5. The TOF-based distance measurement system according to claim 1, wherein the system is dynamically adjusted to realize two modes: a coarse histogram mode and a fine histogram mode; and a time range width in the coarse histogram mode is greater than a time range width in the fine histogram mode.

6. A time of flight (TOF)-based distance measurement method, comprising:
emitting a pulsed beam;
collecting a photon in the pulsed beam reflected by an object to generate a photonic signal; and
receiving the photonic signal, calculating a time interval of the photonic signal, converting the time interval into a time code, counting photons in a corresponding time unit based on the time code, and collecting statistics on photon counts in time units after a plurality of measurements to draw a histogram, wherein
an address of the time unit is dynamically adjusted to dynamically adjust a time resolution and/or a time range width of the histogram.

7. The TOF-based distance measurement method according to claim 6, further comprising:
determining a time corresponding to a pulse waveform in the histogram; and
determining a TOF of the pulsed beam according to the time corresponding to the pulse waveform.

8. The TOF-based distance measurement method according to claim 6, wherein the method is dynamically adjusted to realize two modes: a coarse histogram mode and a fine histogram mode; and a time range width in the coarse histogram mode is greater than a time range width in the fine histogram mode.

9. The TOF-based distance measurement method according to claim 7, wherein the method is dynamically adjusted to realize two modes: a coarse histogram mode and a fine histogram mode; and a time range width in the coarse histogram mode is greater than a time range width in the fine histogram mode.

10. The TOF-based distance measurement method according to claim 8, wherein a first histogram is drawn in the coarse histogram mode, and a second histogram is drawn in the fine histogram mode based on the first histogram.

11. The TOF-based distance measurement method according to claim 9, wherein a first histogram is drawn in the coarse histogram mode, and a second histogram is drawn in the fine histogram mode based on the first histogram.

12. The TOF-based distance measurement method according to claim 10, wherein the second histogram is used to determine a TOF of the pulsed beam.

13. The TOF-based distance measurement method according to claim 11, wherein the second histogram is used to determine the TOF of the pulsed beam.

14. The TOF-based distance measurement method according to claim 6, further comprising:
converting the time code into address information; and
performing an operation of adding one to a photon count of the time unit when the address information is consistent with the address of the time unit or is within an address range of the time unit.
